(19) United States
(12) Patent Application Publication
(10) Pub. No.: US 2017/0169176 A1
(43) Pub. Date: Jun. 15, 2017

(54) CONNECTED MULTIFUNCTION MEDICAL DEVICE

(71) Applicant: SIMEON ABIOLA, Hughesville, MD (US)

(72) Inventor: SIMEON ABIOLA, Hughesville, MD (US)

(21) Appl. No.: 15/373,519

(22) Filed: Dec. 9, 2016

Related U.S. Application Data
(60) Provisional application No. 62/265,636, filed on Dec. 10, 2015.

(51) Int. Cl. G06F 19/00; G06N 3/00; H04L 29/06

(52) U.S. Cl. CPC G06F 19/3418; H04L 63/0428; G06F 19/322; G06F 19/345; G06F 19/3481; G06N 3/006; G06Q 2220/00

(57) ABSTRACT

A multifunction medical device includes a base unit. The base unit includes a plurality of first medical sensors for acquiring first health information, a first wireless radio for transmitting the acquired first health information and second health information to a healthcare entity, and a second wireless radio for receiving the second health information from an accessory device. The accessory device includes a second medical sensor for acquiring the second health information, and a third wireless radio for transmitting the acquired second health information to the second wireless radio of the base unit.

### CROSS-REFERENCE TO RELATED APPLICATION

The present application is based on provisional application Ser. No. 62/265,636, filed Dec. 10, 2015, the entire contents of which are herein incorporated by reference.

### TECHNICAL FIELD

The present disclosure relates to medical devices and, more specifically, to connected multifunction medical devices and methods for using the same.

### DISCUSSION OF THE RELATED ART

Telemedicine is the practice of clinical health care over an electronic network, often over long distances. Today, telemedicine often involves consultation with a healthcare provider remotely, for example, over a videoconference. Telemedicine has the potential to reduce health care costs, especially for patients who are mobility-impaired. Telemedicine can be an invaluable and life-saving tool for serving patients who live in remote areas (e.g. rural areas) and other areas that are underserved by health care providers (e.g. developing nations). Telemedicine can also be used to serve patients in areas that are difficult to reach safely, due to war, political instability, natural disaster, etc. Therefore, the advancement of telemedicine has the potential to save countless lives, particularly among those people who are most vulnerable, and to do so while reducing the cost of healthcare options.

### SUMMARY

A multifunction medical device includes a base unit. The base unit includes a plurality of first medical sensors for acquiring first health information, a first wireless radio for transmitting the acquired first health information and second health information to a healthcare entity, and a second wireless radio for receiving the second health information from an accessory device. The accessory device includes a second medical sensor for acquiring the second health information, and a third wireless radio for transmitting the acquired second health information to the second wireless radio of the base unit.

A multifunction medical device includes a plurality of medical sensors configured to acquire health information. A wireless network adapter is configured to establish communication between the multifunction medical device and a central server. The multifunction medical device is configured to transmit the acquired health information to the central server via the wireless network adapter. A speaker module and a microphone module are configured to establish spoken word communication between the multifunction medical device and an artificial intelligence bot hosted at the central server. The artificial intelligence bot is programmed to guide a patient user of the multifunction medical device in an operation of the multifunction medical device. The operation of the multifunction medical device includes performing a medical examination that is dynamically created, by the artificial intelligence bot, based on the communication with the patient user, electronic medical records, or the health information.

A method for operating a multifunction medical device includes decoupling a transmitter base from the multifunction medical device. The transmitter base includes microphone. A stethoscope head is decoupled from the multifunction medical device. The stethoscope head includes a membrane and a channel for directing sound from the membrane. The stethoscope head is coupled to the transmitter base such that the channel of the stethoscope head is arranged to direct the sound from the membrane to the microphone of the transmitter base. The stethoscope head, coupled to the transmitter base, is used to detect a heartbeat of a patient user of the multifunction medical device, and to wirelessly transmit the detected heartbeat to the multifunction medical device. The detected heartbeat is wirelessly transmitted from the multifunction medical device to a central server or a healthcare provider console.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram illustrating a system for using a connected multifunction medical device in providing patient healthcare in accordance with exemplary embodiments of the present invention;

FIG. 2 is a schematic diagram illustrating a front face of a connected multifunction medical device in accordance with exemplary embodiments of the present invention;

FIG. 3 is a schematic diagram illustrating a back face of a connected multifunction medical device 10 in accordance with exemplary embodiments of the present invention;

FIG. 4 is a cut-away view illustrating a stethoscope head docked to a transmitter base in accordance with exemplary embodiments of the present invention;

FIG. 5 is a schematic diagram illustrating various internal components of the connected multifunction medical device in accordance with exemplary embodiments of the present invention; and

FIG. 6 is a flow chart illustrating an approach for using a connected multifunction medical device in accordance with exemplary embodiments of the present invention.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention relate to a connected multifunction medical device that may be used to quickly and easily assess the health condition of a patient and relay the acquired information, over a wide-area computer network, such as the Internet, to health care providers to facilitate telemedicine. The connected multifunction medical device may include a plurality of different health sensors, which may include an electrocardiogram (EKG), stethoscope, pulse oximeter, spirometer, glucose monitor, dermatoscope, otoscope, thermometer, and/or body fat analyzer. However, other medical sensors may also be integrated. Some of these sensors may be integrated directly into a main body of the connected multifunction medical device. Other sensors may be integrated into removable peripherals that may be tethered to the main body, removably connected to the main body, and/or in wireless communication with the main body.

Each medical sensor acquires heath information relating to the patient and all health information is digitized and transmitted, either directly to a console of a healthcare provider, via a point-to-point connection, or via a central server which mediates the connection between the connected multifunction medical device and the healthcare provider console.

The connected multifunction medical device may additionally include a data storage means, which may be a removable storage means such as a memory card so that acquired health information may be stored locally where network service is unavailable at the time of acquisition.

The connected multifunction medical device may further include a communications device such as a speakerphone, webcam, etc. to facilitate communication between the patient and the healthcare provider. The connected multifunction medical device may further include a small display panel for showing a teleconference with the healthcare provider and/or to display diagrams or video clips providing instructions on how to perform the needed tests.

Patients may then use the connected multifunction medical device, either by themselves, or with the assistance of a friend, family member, paramedic, or caregiver, to acquire the desired health information using the desired medical sensors, for example, by following instructions provided audibly or in the form of an image or video displayed on the display panel.

The display device may also be a touch-screen display device and may additionally serve the purpose of providing the user with an intuitive touch-screen interface for controlling the connected multifunction medical device.

In addition to being useful in telemedicine, exemplary embodiments of the present invention may also be used periodically, or as needed, to perform health checks and logic circuity within the connected multifunction medical device may interpret the health information, along with previously acquired health information, to determine when and if healthcare is required. The logic for making this determination may either be stored locally within the connected multifunction medical device or it may be provided as a cloud-based service. Where the logic is provided as a cloud-based service, the acquired health information may be stored within the cloud-based service, and the healthcare provider may be able to access this information, as needed. The health information may be stored as part of a broader electronic medical records system.

Exemplary embodiments of the present invention may also use the connected multifunction medical device to pull additional heath information acquired from one or more peripheral devices and to store and/or relay this information, along with the health information acquired by the connected multifunction medical device medical sensors, in the manner described herein. These peripheral devices may include exercise/fitness machines, wearable health trackers, smartwatches, and the like.

Accordingly, exemplary embodiments of the present invention may be able to detect and monitor health conditions such as: chronic obstructive pulmonary disease (COPD), abnormal heart rhythms, asthma, diabetes, diabetes-related comorbidities, etc. Additionally, exemplary embodiments of the present invention may be used to gather a complete set of vital signs, analyze body composition, estimate basal metabolic rate and energy expenditure based off oxygen consumption, record and analyze EKG results from treadmill stress test, measure the pulse wave velocity a correlate of blood pressure, and more.

The health information may be stored locally in an encrypted form and may transmit the information to the healthcare provider and/or cloud service in encrypted form. In this way, the health information may be encrypted at rest and in transit. Accordingly, health information may be securely managed in accordance with HIPPA regulations for electronic health records.

Moreover, the connected multifunction medical device may be configured to be carried by or connected to the patient as the patient moves about. The connected multifunction medical device may include various accelerometers and/or gyroscopes to detect general fitness activity and also to detect subtle symptoms of movement that may be indicative of Parkinson's disease or other musculoskeletal disorders.

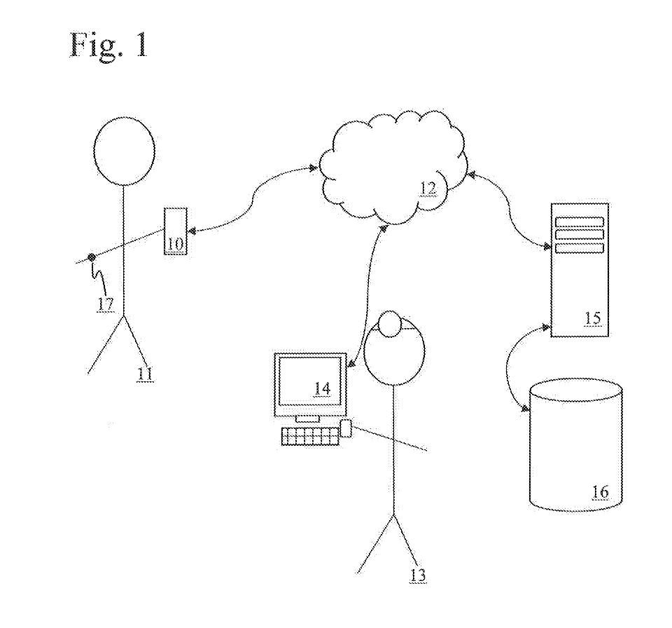

FIG. 1 is a schematic diagram illustrating a system for using a connected multifunction medical device in providing patient healthcare in accordance with exemplary embodiments of the present invention. A patient 11, located at a first location, which may be the patient's home, an ad-hoc medical center, an ambulance, or any other location that may lack trained healthcare providers, may operate a connected multifunction medical device 10 as described herein. The patient may operate the connected multifunction medical device 10 to acquire various health information, such as from the medical sensors of the connected multifunction medical device 10 itself, or from one or more accessory devices such as a wearable fitness tracker 17. Where the connected multifunction medical device 10 receives health information from a wearable fitness tracker 17, this information may be transferred directly from the wearable fitness tracker 17 to the connected multifunction medical device 10, for example, via a Bluetooth connection, or the wearable fitness tracker 17 may transmit information to the connected multifunction medical device 10 via a smartphone device that is paired to the wearable fitness tracker 17, etc.

The health information may be transmitted by the connected multifunction medical device 10 to a healthcare provider 13 and/or medical treatment facility such as a hospital, medical office, etc. The connected multifunction medical device 10 may transmit the health information over a wide area network 12 such as the Internet, either by a point-to-point connection or over a line of connection established and maintained by a central server 15, which may be embodied as a cloud-based service.

The healthcare provider 13 may receive the health information at a healthcare provider console 14, which may be a personal computer, a laptop computer, a tablet computer, a dedicated healthcare provider console appliance, or a smartphone. The healthcare provider 13 may use the connection between the healthcare provider console 14 and the connected multifunction medical device 10 to provide instructions to the patient 11, control tests to be performed by the connected multifunction medical device 10, and to receive and analyze the health information.

According to some exemplary embodiments of the present invention, the healthcare provider 13 may utilize another connected multifunction medical device 10 as a healthcare provider console 14. In these cases, the healthcare provider console 14 may be a connected multifunction medical device 10 having special software installed thereon, or all connected multifunction medical devices 10 may include the capability to function as the healthcare provider console 14. In some embodiments, this capability may be restricted to healthcare providers 13.

Moreover, exemplary embodiments of the present invention may configure the connected multifunction medical device 10 for use even in the absence of the wide area network 12. This may be particularly useful where no Internet access is available, for example, in the event of a loss of Internet connectivity due to technical failures or natural disasters, and, for example, for use in remote and lesser-developed regions where Internet access may not be ubiquitous.

One approach for configuring the connected multifunction medical device 10 for use even in the absence of the wide area network 12 is to configure each multifunction medical device 10 for mesh networking. In this case, several multifunction medical devices 10 may connect with each other, for example, over a WiFi connection, to form a network within which information from each of the multifunction medical devices 10 may pass through each other, as each multifunction medical device 10 becomes a node in the mesh network. Other devices may also function as nodes in the mesh network and, although it is not required, where one or more of the nodes are connected to the Internet, data from any of the other multifunction medical devices 10 that are nodes of the mesh network may transmit data though the nodes that are connected to the Internet. However, this may not be required as the healthcare provider console 14 may also be a node of the mesh network.

However, the connected multifunction medical device 10 may also be used without the real-time participation of a healthcare provider 13. For example, the patient 11 may use the connected multifunction medical device 10 to acquire health information and the health information may be stored locally within the internal and/or external storage of the connected multifunction medical device 10 and/or may be transmitted, via the wide area network 12 to the healthcare provider console 14 for later viewing, and/or may be transmitted, via the wide area network 12 to the central server 15, where the health information may be automatically analyzed by the central server 15 for potential problems. The central server 15 may store the received health information to an electronic medical records database 16 that may be accessible to the healthcare provider 13 and other healthcare providers. The electronic medical records database 16 may also be used by the healthcare provider 13 and other healthcare providers to store other medical information relating to the patient 11 and the central server 15 may make use of this other medical information in performing the automatic analysis.

The automatic analysis of the central server 15 may include periodically or continuously analyzing health information from the electronic medical records database 16 and the connected multifunction medical device 10 to detect risk factors to the patient's health, for example, based on particular health information or trends thereof. Risk factors, when identified, may then be used to generate a health alert, which may be sent to the healthcare provider 13, the patient 11, and others. The logic used by the central server 15 in automatically analyzing the health information may be programmed as a set of rules or may result from computer learning.

According to some exemplary embodiments of the present invention, the logic contained on the central server may also be provided within the connected multifunction medical device 10. In this way, the connected multifunction medical device 10 may be able to be effectively used, in the manner described above, even under circumstances of limited network connectivity and/or limited access to healthcare providers 13. The logic may be stored within a storage device of the connected multifunction medical device 10, such as a flash memory, and this software may be updatable over the Internet, as connectivity is available. This stored logic may be able to guide the patient through an automated examination that is responsive to the health data that is acquired, and the input of the patient. The logic may be programed to offer preliminary diagnosis and raise health risk alerts, even where qualified heath care providers are not available. The logic may also be able to offer remedial guidance such as dietary changes and activity plans, etc. to improve the health of the patient in response to the health data obtained and any available medical history and family history information that the patient may be able to provide, by spoken word input.

Remedial guidance and health risk alerts may also be generated by the central server 15, where available, and the connected multifunction medical device 10 and/or the central server 15 may also be able to issue reminders for the patient to follow the remedial guidance, whether it be issued by the healthcare provider 13 or the logic internal to the connected multifunction medical device 10. These notifications may either be displayed on the connected multifunction medical device 10 itself or sent to the patient's electronic devices, such as mobile phones, smartphones, tablet computers, personal computers, etc. These notifications may also be sent by text message, email, or other forms of communication, whether it be electric or by mail. The notifications may also provide periodic reminders of the need to submit to another medical exam.

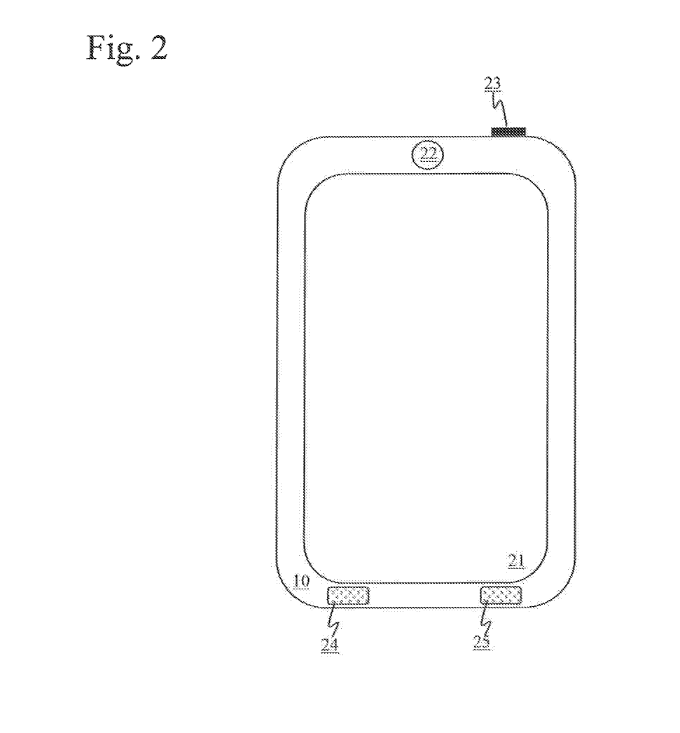

FIG. 2 is a schematic diagram illustrating a front face of a connected multifunction medical device 10 in accordance with exemplary embodiments of the present invention. The connected multifunction medical device 10 may include a display panel 21. The display panel 21 may be a touch-sensitive display panel. The display panel 21 may be used to provide contextual controls to the patient for the purpose of selecting and performing various tests. The display panel 21 may also be used to display teleconference video and/or to show instructional diagrams/videos for helping the patient to perform the tests. The display panel 21 may also be used to administer tests such as by displaying an eye-chart, etc.

The connected multifunction medical device 10 may also include a front-facing camera 22, such as a webcam, that can be used by the patient to participate in teleconference consultations with the healthcare provider. The connected multifunction medical device 10 may also include a button 23 that may be used as a power button, or for other contextual features. The button 23 may include a fingerprint reader for authenticating the patient and/or identifying the patient. However, the fingerprint reader may alternatively be embodied as a separate entity or integrated into the display panel 21.

In addition to the use of a fingerprint reader, or instead of the use of a fingerprint reader, one or more other biometric identification approaches may be used. For example, face recognition software may be used to authenticate a patient on the device. Iris or retina scanners may be used. Voice pattern identification may be used. Additionally, as the connected multifunction medical device 10 includes various medical sensors, these medical sensors may be used to capture biometric data for use in authentication and identification that exceed the capabilities of conventional biometric identification devices. For example, electroencephalography (EEG) sensors may be used to recognize unique brain wave signatures. According to exemplary embodiments of the present invention, one or more of any of the medical sensors described herein may be used for the purposes of authentication or identification of the patient using the connected multifunction medical device 10.

Moreover, in addition to, or rather than using biometrics for authentication, exemplary embodiments of the present invention may utilize biometrics for identification. According to this approach, a patient's existing electronic medical records can be accessed, or new electronic medical records may be created, based on the biometric identification of the patient. In this way, the patient's electronic medical records may be accessed/created even where the patient may not be responsive enough to provide personal information.

According to one exemplary embodiment of the present invention, biometric identification/authentication may be performed as the health information is obtained, as part of medical treatment. In this way, precious time may be saved as the patient's medical records are pulled down as medical aid is being provided, and data from the medical records, so retrieved, may be used to influence the medical tests being performed, as they are being performed.

The connected multifunction medical device 10 may also include one or more microphones/speakers 24 and 25 for use with the aforementioned teleconference consultations and/or to provide audible instructions to the patient. The microphone and speakers may also be used to provide an automated teleconference consultation, for example, with the patient interacting with an artificial intelligence that is responsible for guiding the patient through performing the various tests by providing instructions to the patient in spoken words, asking the patient questions, receiving and interpreting spoken answers, etc. The artificial intelligence may be embodied either locally within the connected multifunction medical device, or may be provided as a cloud-based service. In this way, the connected multifunction medical device may be able to assist the patient in performing a full healthcare consultation, even without the real-time involvement of a healthcare provider. The artificial intelligence may be able to guide the patient through the consultation and may be able to direct the progress of the consultation in accordance with the concerns of the patient, as articulated through natural speech. The artificial intelligence may be regarded as a “bot” which is a computer program designed to communicate with a human user, using natural language, in a manner that is similar to how humans may communicate with each other.

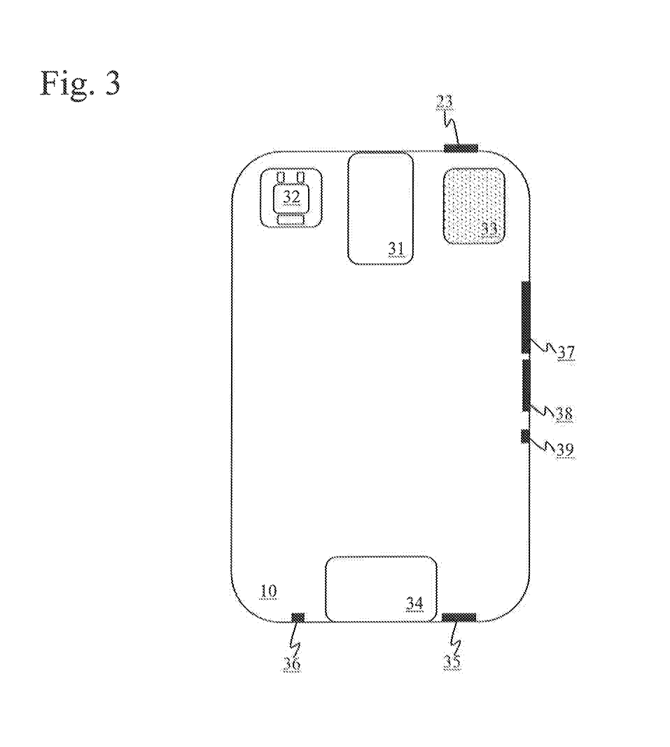

FIG. 3 is a schematic diagram illustrating a back face of a connected multifunction medical device 10 in accordance with exemplary embodiments of the present invention. The connected multifunction medical device 10 may include one or more sockets for receiving various detachable components that may be used to store accessories used to aid in performing various tests. However, the accessories need not all be stored within the connected multifunction medical device 10, and other accessories may be stored separately. For the purpose of providing a simplified depiction, two such sockets are illustrated, one for storing a stethoscope head 31 and another for storing a transmitter base 34, as is described in detail below. These, and other accessories, may be housed within the connected multifunction medical device 10 or may be stored separately.

The connected multifunction medical device 10 may also include a multi-sensor module 32. The multi-sensor module 32 may also be removable, and may retain a connection with the connected multifunction medical device 10 either by a wire tether or a wireless connection such as Bluetooth. The multi-sensor module 32 may include a camera sensor, a flash, a red LED, an IR LED, a microphone, etc. The multi-sensor module 32 may be used to measure pulse rate, oxygen saturation, and may also be used, for example, with the addition of one of a set of caps, as a dermatoscope, otoscope, etc. Each cap may include a shaped-molding and one or more optical elements.

The connected multifunction medical device 10 may also include a back-facing speaker/microphone 33 which may be used in a manner similar to the previously described speakers/microphones 24 and 25, especially during tests in which the back of the connected multifunction medical device 10 is facing the patient.

The connected multifunction medical device 10 may also include a test strip analyzer slot 38 for receiving test strips such as for blood glucose tests, however, other test strips may also be read such as those for testing blood cholesterol and triglycerides. The connected multifunction medical device 10 may also include a flash memory slot 37 to receive a flash memory card for the storing of health data. The health data stored on a flash memory card could be physically sent, for example, by mail, to the healthcare provider in situations where internet access is disrupted or otherwise not available.

The connected multifunction medical device 10 may also include a non-contact temperature sensor 39 for easily measuring the temperature of the patient.

The connected multifunction medical device 10 may also include a microphone device 36 and an accessory port 35. The accessory port 35 may be used to power the connected multifunction medical device 10 and may also be used to connect tethered accessory devices, such as leads for an electrocardiogram ECG and/or electroencephalogram EEG. However, exemplary embodiments of the present invention may alternatively use wireless leads for these purposes.

In acquiring ECG signals, exemplary embodiments of the present invention may be inclined to experience measurement noise due to the presence of large DC offsets and various other interfering signals. The potential for this noise may be up to 300 mV for a typical electrode. The interference signals may include 50-/60-Hz interference from the power supplies, motion artifacts due to patient movement, radio frequency interference from electro-surgery equipment, defibrillation pulses, pace maker pulses, other monitoring equipment, etc. Accordingly, exemplary embodiments of the present invention may include specially engineered discriminating circuits and/or filters to accommodate the expected interference. This noise may also be removed in signal processing, either within the connected multifunction medical device 10 or at the point of data analysis.

Depending on the equipment being used, different accuracies may be needed in an ECG, for example, standard monitoring may use frequencies between 0.05-30 Hz, and diagnostic monitoring may use frequencies from 0.05-1000 Hz.

Some of the 50 Hz/60 Hz common mode interference may be cancelled with a high-input-impedance instrumentation amplifier (INA), which removes the AC line noise common to both inputs. To further reject line power noise, the signal may be inverted and driven back into the patient through the right leg by an amplifier. Only a few micro amps or less might be needed to achieve significant CMR improvement and stay within the UL544 limit. In addition, 50/60 Hz digital notch filters may be used to reduce this interference further.

The accessory port 35 may also be used to connect the connected multifunction medical device 10 to a computer for the transmission of health information or the updating of connected multifunction medical device 10 firmware. The accessory port 35 may be instantiated as a micro-HDMI port, as such a port may be well suited for transmitting the necessary data bandwidth, however other ports may be used such as USB-C.

The connected multifunction medical device 10 may also include a set of pogo pins so that the connected multifunction medical device 10 may be easily docked for recharging, data transmission, or even to dock the connected multifunction medical device 10 into an accessory device.

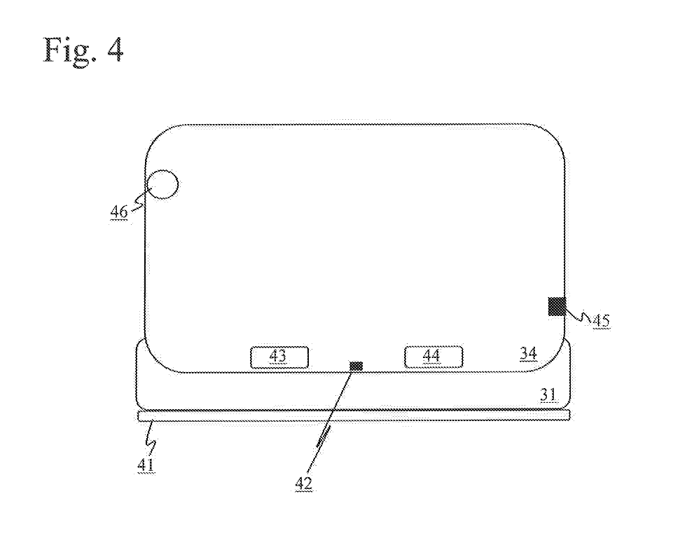

FIG. 4 is a cut-away view illustrating a stethoscope head 31 docked to a transmitter base 34 in accordance with exemplary embodiments of the present invention. The transmitter base 34 may include various sensors such as a high-sensitivity microphone 42, an analogue-to-digital converter and a Bluetooth radio. The transmitter base 34 may also include a battery and charging pins. When docked into the connected multifunction medical device 10, the transmitter base 34 may be recharged. The connected multifunction medical device 10 may include charging pins for this purpose.

When detached from the connected multifunction medical device 10, the transmitter base 34 may maintain a wireless connection to the connected multifunction medical device 10, for example, by Bluetooth. The transmitter base 34 may be docked to one of a variety of different accessories such as the stethoscope head 31. The stethoscope head 31 may be a simple attachment that includes a membrane 41 and a sound conduit for transmitting sound from the membrane 41 to the high-sensitivity microphone 42 of the transmitter base 34. The stethoscope head 31 may be disposable, particularly where the connected multifunction medical device 10 is used to treat multipole patients, for example, when used in the field by first responders and other emergency medical technicians.

The transmitter base 34 may also include a channel for receiving a rail disposed on the stethoscope head 31 so that the two devices may be removably affixed to one another by rail-and-channel. However, alternative means of connection may be used such as friction, magnets, etc. Both the transmitter base 34 and the stethoscope head 31 may be locked into the connected multifunction medical device 10 by similar means.

The transmitter base 34 may also include two or more pressure sensors 43 and 44. The pressure sensors 43 and 44 may allow the transmitter base 34 to be docked to a blow-through tunnel so that a differential pressure flow meter may be created. The pressure sensors 43 and 44 may therefore be used to take spirometry, whereby the patient may blow into the device to measure lung capacity to test for illnesses such as asthma.

The transmitter base 34 may include other sensors such as a temperature sensor 45 so that the patient's temperature may be taken more easily. The transmitter base 34 may also include a camera module 46 so that the transmitter base 34 may be docked to other accessory attachments to act as a laryngoscope, otoscope, etc.

While the removable modules such as the transmitter base 34 and the multi-sensor module 32 have been described herein as connecting to the connected multifunction medical device 10 either by Bluetooth connection or tethered connection. Other wireless protocols may be used, especially where the bandwidth requirements are high. For these purposes a WiFi connection may be used, such as IEEE 802.11 ac or other more advanced wireless protocols.

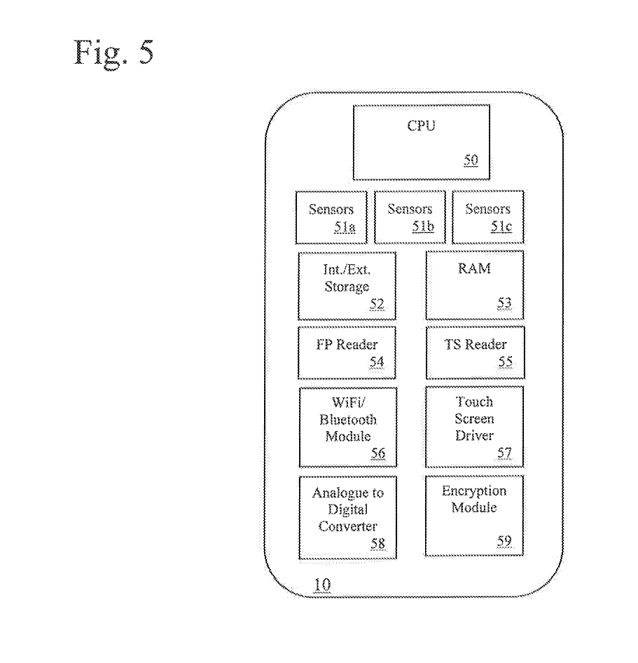

FIG. 5 is a schematic diagram illustrating various internal components of the connected multifunction medical device in accordance with exemplary embodiments of the present invention. The connected multifunction medical device 10 may include a CPU 50. The CPU may be connected to the various other components along a data bus. The other components may include the various aforementioned sensors, shown here as 51a, 51b, and 51c for the purposes of providing a simplified example. An internal storage device and/or an interface for removable storage may be included 52. There may be system memory in the form of random access memory RAM 53. There may be a fingerprint reading sensor 54. The fingerprint reading senor 54 may be configured to detect and identify a fingerprint that may be used to unlock the connected multifunction medical device 10 and/or to identify the patient for the purposes of health data storage and recall. One or more test strip readers 55 may be included. One or more wireless communications modules 56 may be included, such as Bluetooth, WiFi, and other more advanced wireless standards. There may be a touchscreen driver 57 for driving the touchscreen and interpreting touch inputs. An analogue-to-digital converter 58 may be included for converting sensor data into digital form for storage and transmission. An encryption/decryption module 59, which may include a secure memory enclave, may be used for authenticating fingerprints read by the fingerprint sensor 54 and for encrypting/decrypting health information so that this information may be encrypted both at rest and in transit.

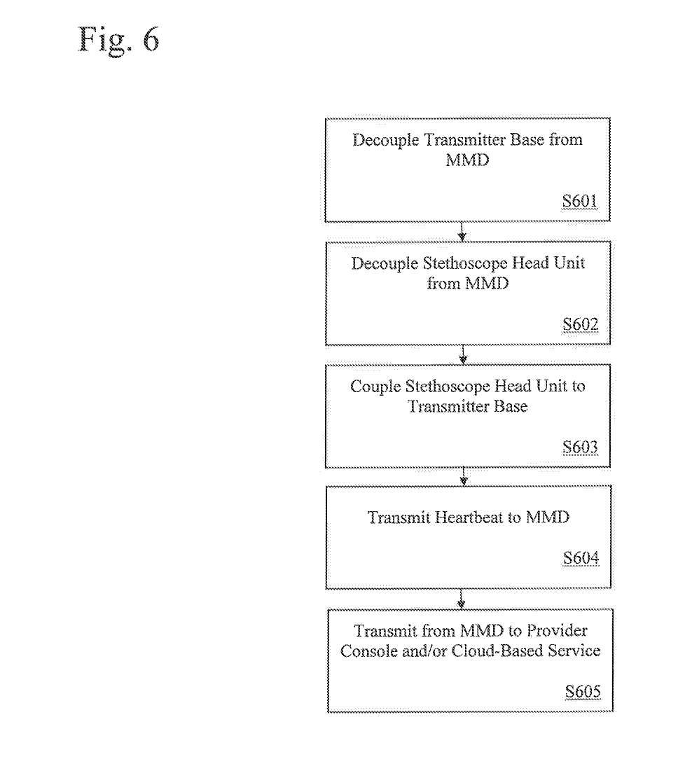

FIG. 6 is a flow chart illustrating an approach for using a connected multifunction medical device in accordance with exemplary embodiments of the present invention.

First, a transmitter base may be decoupled from the multifunction medical device (Step S601). Next, the stethoscope head unit is similarly decoupled from the multifunction medical device (Step S602). As these units may be coupled by friction or magnets, decupling may be performed by pulling the units out of their respective receiving areas. Then the stethoscope head unit may be coupled to the transmitter base (Step S603). By coupling the stethoscope head unit to the transmitter base, a channel of the stethoscope head unit may line up with a microphone of the transmitter base so that sound may be directed from a membrane of the stethoscope head unit to the microphone of the transmitter base.

The patient user of the multifunction medical device may then use the coupled stethoscope head unit/transmitter base to listen to a heartbeat. The heartbeat sound may be directed to the microphone and then transmitted from the transmitter base to the multifunction medical device (Step S604) where it may then be transmitted along with other health information (Step S605).

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A multifunction medical device, comprising:
a base unit comprising: a plurality of first medical sensors for acquiring first health information, a first wireless radio for transmitting the acquired first health information and second health information to a healthcare entity, and a second wireless radio for receiving the second health information from an accessory device; and
the accessory device comprising: a second medical sensor for acquiring the second health information, and a third wireless radio for transmitting the acquired second health information to the second wireless radio of the base unit.

2. The multifunction medical device of claim 1, wherein the accessory device is configured to dock within the base unit for storage and the base unit is configured to charge the accessory device when it is docked thereto.

3. The multifunction medical device of claim 1, wherein the base unit is configured to encrypt the first and second health information prior to transmitting the encrypted first and second health information to the healthcare entity using the first radio.

4. The multifunction medical device of claim 1, wherein the first radio is a WiFi radio or a cellular radio configured to transmit the first and second health information to a wireless router or cellular base station and the healthcare entity is in communication with the wireless router or cellular base station via the Internet.

5. The multifunction medical device of claim 1, wherein the healthcare entity is instantiated as a cloud-based service.

6. The multifunction medical device of claim 1, wherein the healthcare entity is a clinical healthcare facility.

7. The multifunction medical device of claim 1, wherein the base unit further includes a display device, a microphone, and a camera module that are configured to execute a teleconference with the healthcare entity.

8. The multifunction medical device of claim 1, wherein the base unit further includes a display device, a microphone, and a camera module that are configured to execute an artificial intelligence user interface for communicating with a patient user of the multifunction medical device, by spoken words, to guide the patent user in the operation of the multifunction medical device, the operation of the multifunction medical device including a performance of a medical examination that is dynamically created, by the artificial intelligence user interface, based on the communication with the patient user, electronic medical records, or the first or second health information.

9. The multifunction medical device of claim 8, wherein, after the performance of the medical examination, the artificial intelligence guides the patient user in an administration of medical treatment.

10. The multifunction medical device of claim 1, wherein the artificial intelligence user interface is instantiated, at least partially, as a cloud-based service.

11. The multifunction medical device of claim 1:
wherein the accessory device is a first accessory device,
wherein the second medical sensor of the first accessory device comprises a microphone,
wherein the first accessory device is configured to mate with a second accessory device, and
wherein the second accessory device includes a stethoscope membrane and a sound conduit for channeling sound from the stethoscope membrane to the microphone of the first accessory device.

12. The multifunction medical device of claim 11, wherein each of the first and second accessory devices dock into the base unit.

13. The multifunction medical device of claim 1, wherein the base unit further comprises an accessory port for connecting a third medical sensor to the base unit.

14. The multifunction medical device of claim 13, wherein the third medical sensor includes electrocardiogram (ECG) or electroencephalogram (EEG) electrodes.

15. The multifunction medical device of claim 1, wherein at least one of the plurality of first medical sensors is a test strip reader.

16. The multifunction medical device of claim 1, wherein either the first health information or the second health information is used as biometric data to authenticate or identify a patient using the multifunction medical device.

17. A multifunction medical device, comprising:
a plurality of medical sensors configured to acquire health information;
a wireless network adapter configured to establish communication between the multifunction medical device and a central server, the multifunction medical device configured to transmit the acquired health information to the central server via the wireless network adapter; and
a speaker module and a microphone module configured to establish spoken word communication between the multifunction medical device and an artificial intelligence bot hosted at the central server, the artificial intelligence bot programmed to guide a patient user of the multifunction medical device in an operation of the multifunction medical device, the operation of the multifunction medical device including a performance of a medical examination that is dynamically created, by the artificial intelligence bot, based on the communication with the patient user, electronic medical records, or the health information.

18. The multifunction medical device of claim 17, wherein, after the performance of the medical examination, the artificial intelligence guides the patient user in an administration of medical treatment.

19. A method for operating a multifunction medical device, comprising:
decoupling a transmitter base from the multifunction medical device, the transmitter base including a microphone;
decoupling a stethoscope head from the multifunction medical device, the stethoscope head including a membrane and a channel for directing sound from the membrane;
coupling the stethoscope head to the transmitter base such that the channel of the stethoscope head is arranged to direct the sound from the membrane to the microphone of the transmitter base;
using the stethoscope head, coupled to the transmitter base to detect a heartbeat of a patient user of the multifunction medical device, and to wirelessly transmit the detected heartbeat to the multifunction medical device; and
wirelessly transmitting the detected heartbeat from the multifunction medical device to a central server or a healthcare provider console.

20. The method of claim 19, wherein the transmitter base is charged by the multifunction medical device when coupled thereto.

21. The method of claim 19, wherein the multifunction medical device includes a plurality of medical sensors acquiring health information and the acquired health information is wirelessly transmitted from the multifunction medical device to the central server or the healthcare provider console.

22. The method of claim 21, wherein the multifunction medical device encrypts the detected heartbeat and the acquired health information prior to transmitting the detected heartbeat and the acquired health information to the central server or the healthcare provider console.
